(19) United States
(12) Patent Application Publication
(10) Pub. No.: US 2020/0390027 A1
(43) Pub. Date: Dec. 17, 2020

(54) SHARPENED EDGE YARD TOOL

(71) Applicant: The Ames Companies, Inc., Camp Hill, PA (US)

(72) Inventors: Jeff KOENIG, Mechanicsburg, PA (US); John Aaron PRESSLEY, Harrisburg, PA (US)

(21) Appl. No.: 16/895,252

(22) Filed: Jun. 8, 2020

Related U.S. Application Data
(60) Provisional application No. 62/861,494, filed on Jun. 14, 2019.

(51) Int. Cl. A01D 7/02; A01B 1/02; A01B 1/08; E21B 11/00; B21K 5/12

(52) U.S. Cl. CPC A01D 7/02; A01B 1/02; B21K 5/12; E21B 11/005; A01B 1/08

(57) ABSTRACT

A yard tool blade is provided with a distal edge to dig a work material, with a surface to support the work material and an adaptor at a proximal end for receipt of a handle. The distal edge is sharpened to an angle within a tolerance of forty to fifty degrees for a reduced thickness to cut the work material. A method for manufacturing the yard tool blade forms a yard tool blade blank. A cutting edge is machined on a distal edge of the yard tool blade blank. The yard tool blade blank is formed into a shaped yard tool blade. The shaped yard tool blade is heat treated after the cutting edge is machined on the distal edge.

### CROSS-REFERENCE TO RELATED APPLICATIONS

This application claims the benefit of U.S. provisional application Ser. No. 62/861,494 filed Jun. 14, 2019, the disclosure of which is hereby incorporated in its entirety by reference herein.

### TECHNICAL FIELD

Various embodiments relate to yard tools.

### BACKGROUND

The prior art has provided sharpened edge shovels with shovel blades that are hand sharpened after the shovel blade is stamped.

### SUMMARY

According to an embodiment, a method for manufacturing a yard tool blade forms a yard tool blade blank. A cutting edge is machined on a distal edge of the tool blade blank. The yard tool blade blank is formed into a shaped yard tool blade. The shaped yard tool blade is heat treated after the cutting edge is machined on the distal edge.

According to a further embodiment, the yard tool blade blank is stamped from flat steel.

According to another further embodiment, the cutting edge is machined within a range of forty to fifty degrees.

According to another further embodiment, the yard tool blade blank is stamped into a curved yard tool blade before heat treating the shaped yard tool blade.

According to at least another embodiment, a yard tool blade is manufactured from a method by forming a yard tool blade blank. A cutting edge is machined on a distal edge of the yard tool blade blank. The yard tool blade blank is formed into a shaped yard tool blade. The shaped yard tool blade is heat treated after the cutting edge is machined on the distal edge.

According to at least one embodiment, a yard tool blade is provided with a distal edge to dig a work material, with a surface to support the work material and an adaptor at a proximal end for receipt of a handle. The distal edge is sharpened to an angle within a tolerance of forty to fifty degrees for a reduced thickness to cut the work material.

According to a further embodiment, the yard tool blade has a hardness within a tolerance of thirty-eight to forty-seven HRC Rockwell hardness.

According to another further embodiment, a radius is formed along the distal edge, that is within a range of 0.006 to 0.025 inches.

According to another further embodiment, the yard tool blade is curved to provide a curved work material surface.

According to another further embodiment, the sharpened angle of the distal edge is within a tolerance of forty-three to forty-seven degrees.

According to another further embodiment, the sharpened angle of the distal edge is forty-two and one-half degrees.

According to another further embodiment, the yard tool blade provides a shovel blade for a shovel.

According to an even further embodiment, the shovel blade comprises a round point shovel blade, a square point shovel blade, a drain spade shovel blade, a trenching shovel blade, or a garden spade shovel blade.

According to another further embodiment, the yard tool blade provides a hoe blade.

According to another further embodiment, the yard tool blade provides a rake blade.

According to another embodiment, a shovel is provided with a yard tool blade with a distal edge to dig a work material, with a surface to support the work material and an adaptor at a proximal end for receipt of a handle. The distal edge is sharpened to an angle within a tolerance of forty to fifty degrees for a reduced thickness to cut the work material. The yard tool blade provides a shovel blade for a shovel. A handle is received in the adaptor.

According to another embodiment, a hoe is provided with a yard tool blade with a distal edge to dig a work material, with a surface to support the work material and an adaptor at a proximal end for receipt of a handle. The distal edge is sharpened to an angle within a tolerance of forty to fifty degrees for a reduced thickness to cut the work material. The yard tool blade provides a hoe blade for a hoe. A handle is received in the adaptor.

According to another embodiment, a rake is provided with a yard tool blade with a distal edge to dig a work material, with a surface to support the work material and an adaptor at a proximal end for receipt of a handle. The distal edge is sharpened to an angle within a tolerance of forty to fifty degrees for a reduced thickness to cut the work material. The yard tool blade provides a rake blade for a rake. A handle is received in the adaptor.

According to at least one embodiment, a post hole digger blade is provided with a distal edge to dig a work material, with a surface to support the work material and an adaptor at a proximal end for receipt of a handle. The distal edge is sharpened to an angle within a tolerance of thirty to fifty degrees for a reduced thickness to cut the work material.

According to another embodiment, a post hole digger is provided with a pair of post hole digger blades pivotally connected together. Each post hole digger blade is provided with a distal edge to dig a work material, with a surface to support the work material and an adaptor at a proximal end for receipt of a handle. The distal edge is sharpened to an angle within a tolerance of thirty to fifty degrees for a reduced thickness to cut the work material. A pair of handles is each received in the adaptor of one of the pair of post hole digger blades.

### BRIEF DESCRIPTION OF THE DRAWINGS

FIG. 1 is a front perspective view of a round point shovel according to an embodiment;

FIG. 2 is a top plan view of round point shovel blade blank according to an embodiment;

FIG. 3 is an enlarged partial section view of the round point shovel blade blank of FIG. 2 taken along section line 3-3 in FIG. 2;

FIG. 4 is a front perspective view of a square point shovel according to another embodiment;

FIG. 5 is a front perspective view of a drain spade shovel according to another embodiment;

FIG. 6 is a front perspective view of a trenching shovel according to another embodiment;

FIG. 7 is a front perspective view of a post hole digger according to another embodiment;

FIG. 8 is a front perspective view of a hoe according to another embodiment;

FIG. 9 is a front perspective view of a rake according to another embodiment; and

FIG. 10 is front perspective view of a garden spade shovel according to another embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

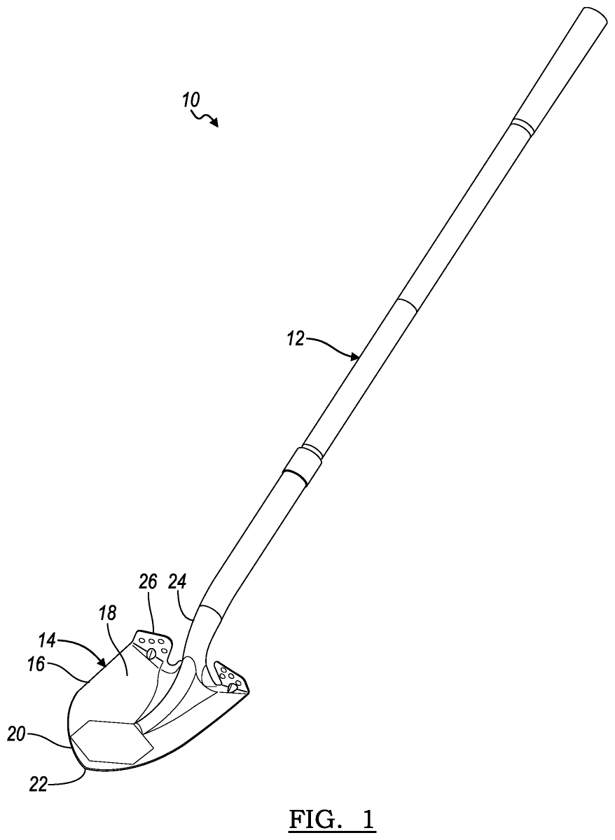

FIG. 1 illustrates a yard tool according to an embodiment. For the depicted embodiment, the yard tool is a round point shovel 10. The shovel 10 includes a handle 12 and a blade 14. The blade 14 is a round point shovel blade 14, however any shovel blade configuration is contemplated. The handle 12 may be formed from wood, metal, fiberglass or any suitable material with any suitable grip surface. The blade 14 is formed from metal, such as tempered steel.

The shovel 10 is employed for manually digging and moving bulk materials, such as soil, dirt, gravel and the like. The shovel blade 14 has a blade body 16 with a length and width to define a surface 18 for supporting work materials upon the blade 14. A distal edge 20 of the shovel blade 14 is employed for digging or otherwise separating work materials. For the depicted embodiment, the distal edge 20 is rounded with a point 22 for use in digging.

The shovel blade 14 includes an adaptor, such as a socket 24, oriented centrally at a proximal end for receipt of, and connection to, the handle 12. A pair of tread plates 26 are formed on either side of the socket 24 to provide a stepping surface for a foot of an operator to press the shovel blade 14 into the work material, if desired. For the illustrated embodiment, the shovel blade 14 is formed from stamped metal with a generally uniform thickness, which is consequently shaped and formed to define the socket 24 and the tread plates 26.

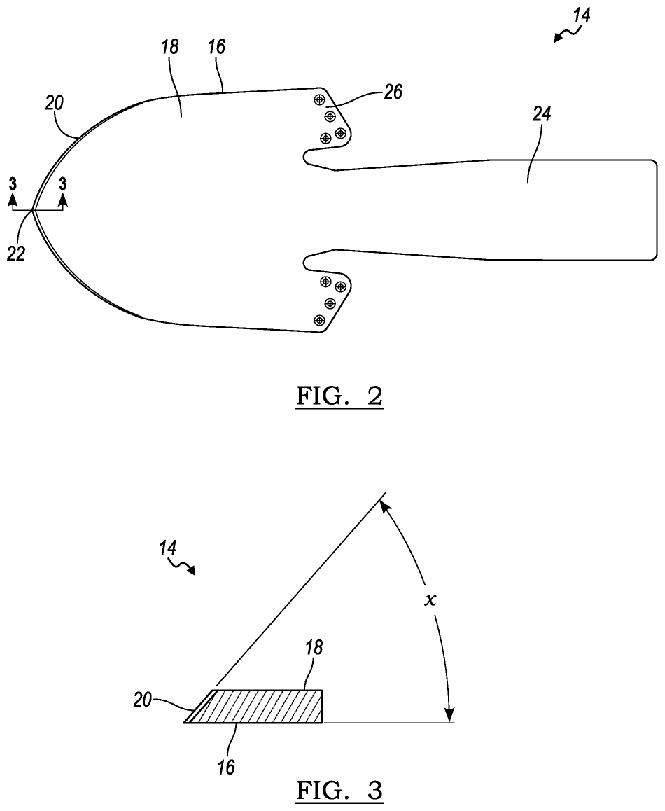

FIG. 2 illustrates the shovel blade 14 as a shovel blade blank 14, which is cut as a flat shape from stamped steel. Next, the distal edge 20 is machined with automated cutting tools to a reduced, tapered thickness. The shovel blade 14 is fixed and the grinder moves along the distal edge 20. Alternatively, the grinder is stationary and the shovel blade 14 is actuated relative to the grinder.

FIG. 3 illustrates an enlarged partial section view of the shovel blade blank 14 taken through the distal edge 20. The distal edge 20 has a reduced, tapered thickness for cutting the work material, such as digging into soil. The distal edge 20 is sharpened relative to the stamped shovel blade blank 14. In the depicted embodiment, the distal edge 20 is sharpened to an angle x, which may be within a range of forty to fifty degrees. According to empirical testing and applicable tolerances, the angle x may be forty-three to forty-seven degrees. For the depicted embodiment, the angle x is forty-two and one-half degrees. The angle x may alternatively be forty-five degrees. The angle x is formed by machining material from the work surface 18 of the shovel blade blank 14.

After the cutting edge 20 is formed into the distal edge 20, then the shovel blade blank 14 is subjected to stamping and forming operations to form the curved shape of the blade body 16, and to also form the socket 24 and the tread plates 26. Once the end shape of the shovel blade 14 is obtained, the shovel blade 14 is heat treated and tempered to have a desired hardness, such as thirty-eight to forty-seven HRC Rockwell hardness. Other finishing processes may be applied, such as shot blasting, painting, clearcoat and the like. Additionally, stickers, labels and other indicia may be applied to the finished shovel blade 14. The handle 12 is installed into the socket 24 and the shovel 10 is ready for retail and use.

By machining the cutting edge 20 into the distal edge 20 while the shovel blade 14 is a blank 14 as depicted in FIG. 2, strict tolerances can be obtained, such as within one thousandth of an inch. Such tolerances permit the machining operation of the cutting edge 20 to be automated, such as by use of robotics and automated cutting tools. Otherwise, if the machining were attempted after the shaping, forming and heat treating of the shovel blade 14, such machining would require manual operation due to tolerance variances after the multiple manufacturing processes to shape, form and harden the shovel blade 14.

Various testing was performed on various shovels, including the round tip shovel 10, for various angles x for the distal cutting edge 20. For example, the angle x was tested at thirty-five, forty, and forty-five degrees, all in comparison to the prior art edge. The testing applied increasing forces on each of the shovel blades 14 into a common foam work material to a predetermined depth of five inches. The dimensions and density of the foam material was maintained for all samples.

The sharpened cutting edge 20 of all tested angles x provided an increase in performance that was detected. For the cutting edge 20 at an angle x of forty-two and one-half degrees, a reduction of force of forty-two percent to fifty-three percent was detected for the various shovel blades 14. This increased performance significantly reduces the effort required by the end user in order to dig in a work material, thereby significantly increasing the output. For shovel blades 14 that reduce effort of up to fifty percent, the digging operation becomes twice as easy to the end user. The prior art method of manually sharpening the blades does not maintain the sharpness tolerances that result in the performance characteristics associated with the desired sharpness ranges. Likewise, sharpening the blades after the shaping process does not obtain the sharpness tolerances due to tolerance variations in the shaping processes.

Although the cutting edge 20 is sharpened, the cutting edge 20 is still adequately blunt at forty-five degrees to minimize inadvertent cutting except for upon the work material. The bluntness of the cutting edge 20 is provided by forming a radius along the cutting edge 20. A suitable radius is formed within a range of 0.006 to 0.025 inches. The cutting edges 20 were subjected to applicable sharpness tests to ensure that the shovel blades 14 fall within industry set limits of sharpness to yard hand tools.

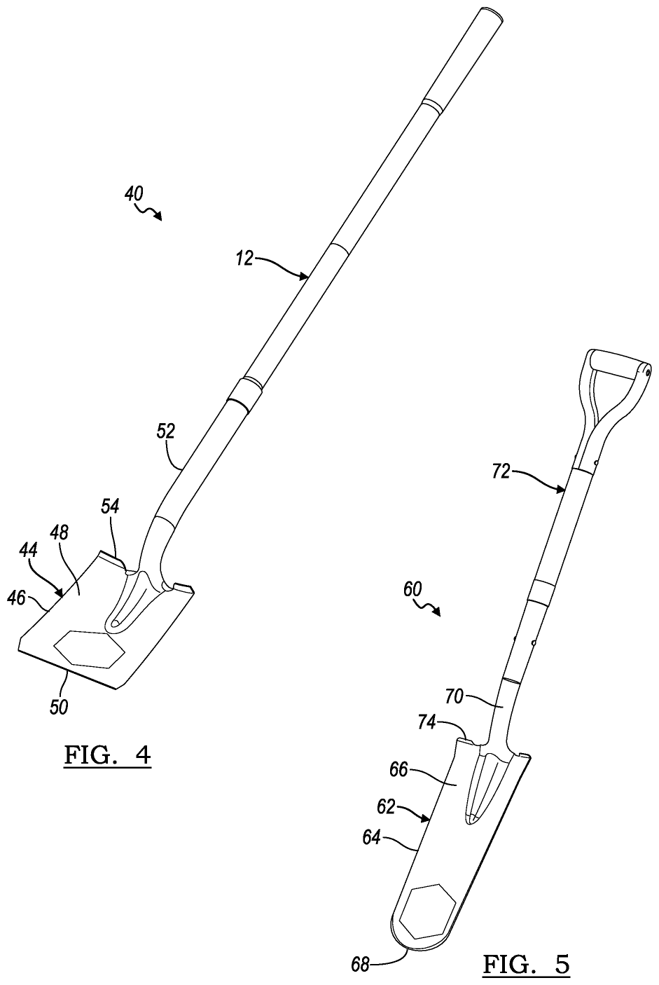

Another manual yard tool that benefits from the cutting edge is a square point shovel 40 with a square point shovel blade 44 in FIG. 4. The square point shovel blade 44 includes a blade body 46 with a work surface 48. A cutting edge 50 is formed along the distal edge with an angle x of approximately forty-two and one-half degrees similar to the prior embodiment. A socket 52 receives the handle 12, and a pair of tread plates 54 permit the user to apply a force upon the shovel blade 44.

FIG. 5 illustrates another manual yard tool such as a drain spade shovel 60 with a drain spade shovel blade 62. The drain spade shovel blade 62 includes a blade body 64 with a work surface 66. A cutting edge 68 is formed along the distal edge with an angle x of approximately forty-two and one-half degrees similar to the prior embodiments. A socket 70 receives a handle 72. A pair of tread plates 74 permit the user to apply a force upon the shovel blade 62.

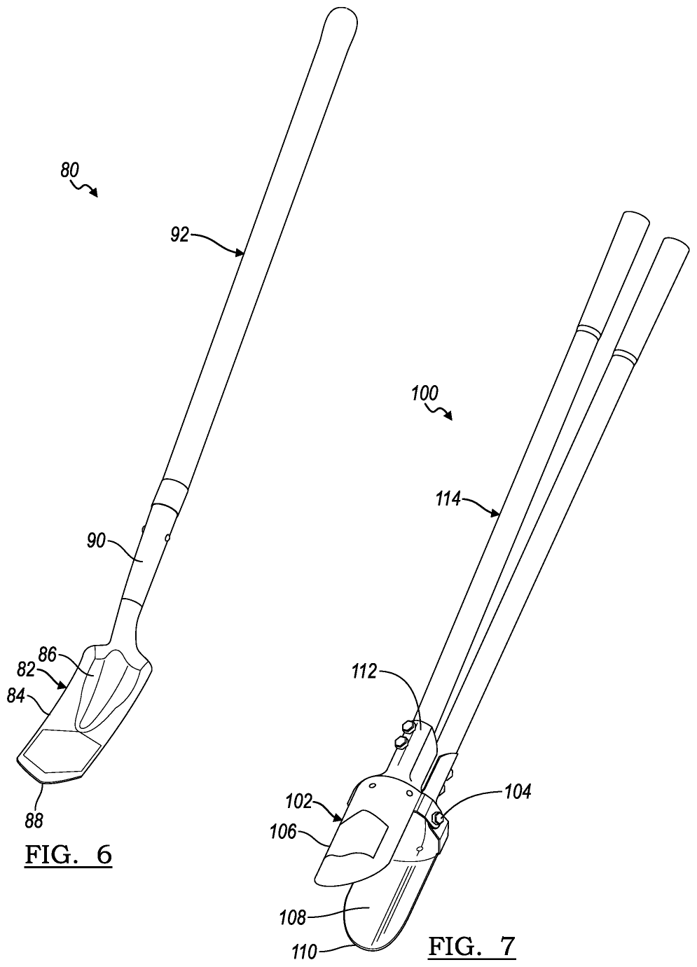

FIG. 6 illustrates a trenching shovel 80 with a trenching shovel blade 82. The trenching shovel blade 82 includes a blade body 84 with a work surface 86. A cutting edge 88 is formed along the distal edge with an angle x of approximately forty-two and one-half degrees similar to the prior embodiments. A socket 90 receives a handle 92.

FIG. 7 illustrates a post hole digger 100 with a pair of post hole digger blades 102 that are pivotally connected at pivot shaft 104. Each post hole digger blade 102 includes a blade body 106 with a work surface 108. A cutting edge 110 is formed along the distal edge of each post hole digger blade 102 with an angle x of approximately forty-two and one-half degrees similar to the prior embodiments. Alternatively, the angle x of the cutting edge 110 may be thirty-five degrees for the post hole digger blades 102. Each post hole digger blade 102 includes a socket 112 to receive a handle 114.

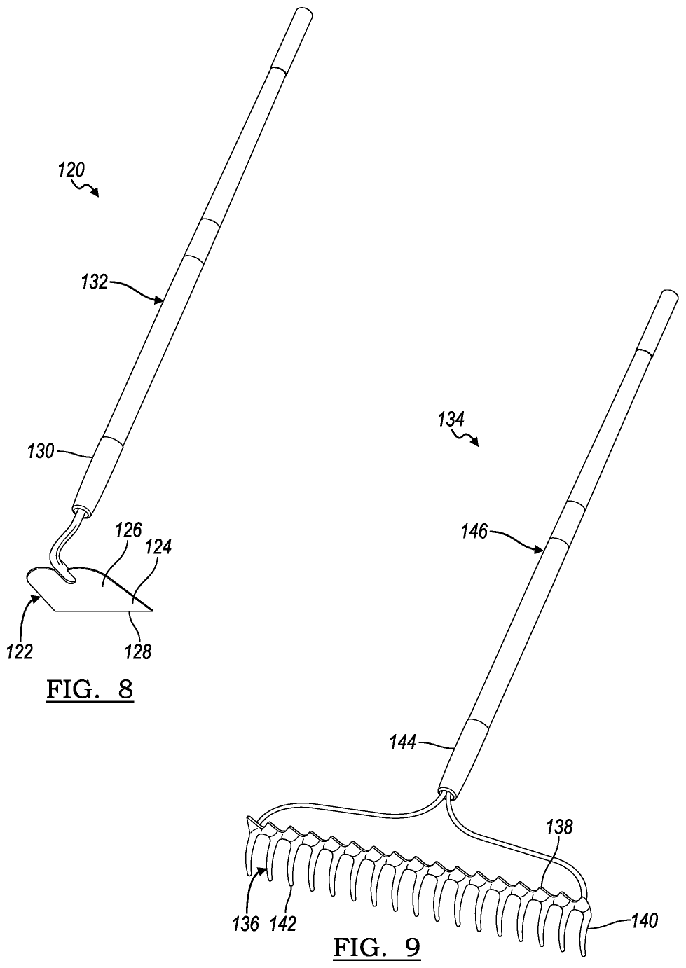

FIG. 8 illustrates a hoe 120 with a hoe blade 122. The hoe blade 122 includes a blade body 124 with a work surface 126. A cutting edge 128 is formed along the distal edge with an angle x of approximately forty-two and one-half degrees similar to the prior embodiments. A socket 130 receives a handle 132.

FIG. 9 illustrates a rake 134 with a rake blade 136. The rake blade 136 includes a blade body 138 with tines 140. A cutting edge 142 is formed along the distal edge of each tine 140 with an angle x of approximately forty-two and one-half degrees similar to the prior embodiments. A socket 144 receives a handle 146.

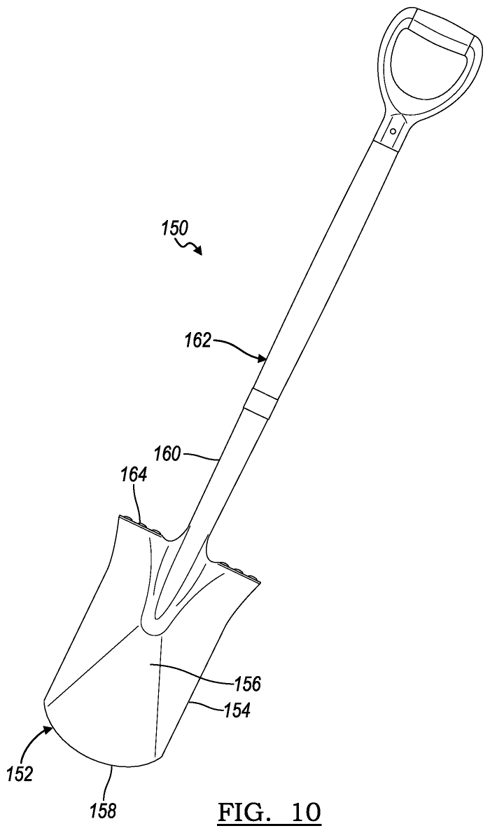

FIG. 10 illustrates another manual yard tool such as a garden spade shovel 150 with a garden spade shovel blade 152. The garden spade shovel blade 152 includes a blade body 154 with a work surface 156. A cutting edge 158 is formed along the distal edge with an angle x of approximately forty-two and one-half degrees similar to the prior embodiments. A socket 160 receives a handle 162. A pair of tread plates 164 permit the user to apply a force upon the shovel blade 152.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for manufacturing a yard tool blade comprising:
forming a yard tool blade blank;
machining a cutting edge on a distal edge of the yard tool blade blank;
forming the yard tool blade blank into a shaped yard tool blade; and
heat treating the shaped yard tool blade after the cutting edge is machined on the distal edge.

2. The method of claim 1 further comprising stamping the yard tool blade blank from flat steel.

3. The method of claim 1 further comprising machining the cutting edge within a range of forty to fifty degrees.

4. The method of claim 1 further comprising stamping the yard tool blade blank into a curved yard tool blade before heat treating the shaped yard tool blade.

5. A yard tool blade manufactured from a method comprising:
forming a yard tool blade blank;
machining a cutting edge on a distal edge of the yard tool blade blank;
forming the yard tool blade blank into a shaped yard tool blade; and
heat treating the shaped yard tool blade after the cutting edge is machined on the distal edge.

6. A yard tool blade with a distal edge to dig a work material, with a surface to support the work material, and an adaptor at a proximal end for receipt of a handle, wherein the distal edge is sharpened to an angle within a tolerance of forty to fifty degrees for a reduced thickness to cut the work material.

7. The yard tool blade of claim 6 wherein the yard tool blade has a hardness within a tolerance of thirty-eight to forty-seven HRC Rockwell hardness.

8. The yard tool blade of claim 6 wherein a radius is formed along the distal edge, that is within a range of 0.006 to 0.025 inches.

9. The yard tool blade of claim 6 wherein the yard tool blade is curved to provide a curved work material surface.

10. The yard tool blade of claim 6 wherein the sharpened angle of the distal edge is within a tolerance of forty-three to forty-seven degrees.

11. The yard tool blade of claim 6 wherein the sharpened angle of the distal edge is forty-two and one-half degrees.

12. The yard tool blade of claim 6 wherein the yard tool blade comprises a shovel blade for a shovel.

13. A shovel comprising:
the shovel blade of claim 12; and
a handle received in the adaptor.

14. The yard tool blade of claim 12 wherein the shovel blade comprises a round point shovel blade, a square point shovel blade, a drain spade shovel blade, a trenching shovel blade, or a garden spade shovel blade.

15. The yard tool blade of claim 6 wherein the yard tool blade comprises a hoe blade.

16. A hoe comprising:
the hoe blade of claim 15; and
a handle received in the adaptor.

17. The yard tool blade of claim 6 wherein the yard tool blade comprises a rake blade.

18. A rake comprising:
the rake blade of claim 17; and
a handle received in the adaptor.

19. A post hole digger blade with a distal edge to dig a work material, with a surface to support the work material, and an adaptor at a proximal end for receipt of a handle, wherein the distal edge is sharpened to an angle within a tolerance of thirty to fifty degrees for a reduced thickness to cut the work material.

20. A post hole digger comprising:
a pair of post hole digger blades of claim 19 pivotally connected together; and
a pair of handles each received in the adaptor of one of the pair of post hole digger blades.
